(19) United States
(12) Patent Application Publication
(10) Pub. No.: US 2008/0172925 A1
(43) Pub. Date: Jul. 24, 2008

(54) Dive plane

(76) Inventor: Michael W. Hazel, Greenacres, FL (US)

Correspondence Address: ROBERT M. DOWNEY, P.A., 6751 N. FEDERAL HWY., SUITE 300, BOCA RATON, FL, 33487, US

(21) Appl. No.: 11/655,617

(22) Filed: Jan. 18, 2007

(51) Int. Cl. A01K 91/08

(52) U.S. Cl. 43/43.13

(57) ABSTRACT

A dive plane is used with fishing tackle for maintaining a fishing lure in a submerged state when trolling for fish at speeds between 12 and 20 knots. The dive plane has a body with a cross-section in the form of a cruciform. The cross-section defines upper and lower vertical segments and right and left horizontal planing segments. The body also has at least one rear aperture at a back end for connection of a leader and lure and at least two vertically spaced front holes along a front edge of the upper vertical segment for selective connection of the fishing line according to a desired trolling speed and diving depth of the trolled lure.

### BACKGROUND OF THE INVENTION

1. Field of the Invention

The present invention relates to equipment for sport fishing, and, more particularly, to a dive plane for keeping a fishing lure submerged to a desired water depth while trolling for fish at higher speeds.

2. Discussion of the Related Art

Sport fishing has long been a popular outdoor sports activity and a vital segment of the tourist economy in many places. In particular, salt water fishing in bays and on the open ocean accounts for a large segment of the outdoor sports industry. When the subject of deep sea sport fishing is raised, most individuals immediately think of large fighting fish such as marlin, shark, or sailfish. Another highly sought after fish in the world of sport fishing is the wahoo, particularly since this fish is fast, a tough fighter and also an excellent source of food. The wahoo is one of the oceans fastest fish, being a predator that feeds on fast swimming fish such as tuna, bonita, speedos, and small dolphin (mahi-mahi).

Wahoo fishing can be performed using live bait. However, the most common technique for wahoo fishing is high speed trolling, generally at speeds ranging between 12-18 knots. Trolling lures at slower speeds can result in attracting wahoo, but the fast swimming predator will usually swim alongside a lure trolled below 10 knots, become suspicious, and then turn away. Trolling at high speeds triggers the fish's instinct such that the wahoo no longer has time to merely investigate the lure. In the mind of a wahoo, anything moving at the high trolling speed must be evading a predator and, therefore, must be prey. Sport fishermen will sometimes put a wahoo lure out when running between lines of floating sea weed looking for dolphin. They occasionally hook a wahoo while the boat is up on plane and traveling at 12-20 knots. Tournament fishermen have found that by increasing the trolling speed, they had more fish strikes than at slower speeds. However, a problem with trolling fast is that more weight is required to keep the lure below the surface of the water. At extreme speeds, weights of 4-5 pounds are sometimes necessary to keep the lure submerged.

When trolling for wahoo, experienced fishermen use cigar shaped lead trolling sinkers and large torpedo shaped trolling lures which are also at least partially made of lead. The large quantity of lead is required to provide sufficient weight to keep the lure running below the water surface at the high trolling speeds necessary for attracting and catching wahoo. Other types of downriggers, planing devices, and depth control devices exist, but usually require an additional release device or surfacing device to eliminate excessive drag when fighting and landing the fish. The excessive drag produced by these devices does not allow for high speed trolling.

A further problem of high speed trolling is that heavy and expensive tackle is required to not only handle the weight of the sinkers and lures at these speeds, but also the weight and fighting force of the fish. A hooked wahoo can exceed 100 pounds and, when swimming at extreme speeds in the opposite direction for runs of over 100 yards at a time, the pull on the line and reel can be substantial. Once a wahoo is hooked, and during the fight with the fish, the boat must keep moving forward because the pull of the heavy weight of the trolling sinkers and lure causes the hook to open a large hole in the wahoo's mouth. Once the hole in the mouth becomes enlarged, the violent head shaking of the wahoo can allow the fish to spit the hook out of its mouth. In sport fishing, many prize fish are lost in this manner, sometimes after hours of fighting the fish on the line.

A number of problems exist with using the heavy weight of fishing tackle now in general use and required for wahoo trolling. During the landing of a fish, the heavy sinkers are reeled to the rod tip which causes a serious balance problem for the fisherman holding the rod. Sometimes, in order to eliminate the need for the lead sinkers, lead core fishing line or steel line is spooled onto the fishing reel. In this configuration, a heavy lure is still required and lots of line needs to be trailed to keep the lure down at a desired depth. These configurations require substantially stronger rods and reels to handle the large weights being trolled. Such heavy tackle is extremely expensive, thereby making occasional wahoo fishing substantially more difficult and expensive for a weekend angler. Further, unless great care is taken by the fisherman, the heavy sinkers swinging from the end of the rod pose a serious threat of injury to people on the boat, as well as the definite possibility of damage to the boat.

The heavy lure can also be very dangerous when the wahoo is landed in the boat. A wahoo will violently shake its head and in the process can launch the lure out of its mouth at someone or at an expensive piece of equipment. While holding the weighted trolling lure, the lure head may fall down the leader, carrying the hooks with it, and cause injury to the fisherman. In rigging a boat for wahoo trolling, a typical fisherman can have a dozen sinkers and twice as many lures.

Thus, what is desired is a lightweight device that will keep a fishing lure submerged during high speed trolling, thereby eliminating the need for heavy lead sinkers and expensive tackle in sport fishing, and particularly wahoo fishing.

### SUMMARY OF THE INVENTION

The present invention is directed to a dive plane that is rigged in-line for keeping a fishing lure submerged at high trolling speeds. The dive plane of the present invention satisfies the need for a device that replaces undesirable heavy sinkers and tackle. The dive plane has a body with a cross-section that defines upper and lower vertical segments and right and left horizontal planing segments. The body also has at least one rear aperture at a back end for affixing a leader and lure. A plurality of vertically spaced front holes along a front edge of the upper vertical segment allow for selective attachment of the fishing line according to a desired trolling speed and depth.

Another aspect of the present invention is a dive plane for use with fishing tackle for maintaining a fishing lure in a submerged state during high speed trolling for fish. The dive plane has a vertical plate with upper and lower edges and front and rear edges. The vertical plate also has a plurality of front holes proximate to its front edge and a plurality of apertures proximate to its rear edge. A horizontal planing element extends from the opposite sides of the vertical plate and separates the horizontal element into right and left horizontal planing segments.

Yet another aspect of the present invention is a dive plane for use with fishing tackle for maintaining a fishing lure in a submerged state during high speed trolling for fish. The dive plane includes a central vertical planar plate having a front end and a back end. The plate divergently tapers from its front end toward its back end and terminates at both the top edge and the bottom edge of the plate at a point intermediately between the front and back ends. The taper further defines an upper tapered edge and a lower tapered edge. The central plate also includes a plurality of holes spaced along proximate to the upper tapered edge and at least one aperture at a back end thereof. A horizontal planing element extending from the opposite sides of the vertical plate has right and left horizontal planing segments.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is an elevational view of a dive plane embodying the present invention affixed to a fishing rod and being trolled behind a boat;

FIG. 1A is an isolated elevational view of the dive plane, leader and lure assembly of FIG. 1;

FIG. 2 is a perspective of a dive plane according to the present invention;

FIG. 3 is an elevational view of the dive plane shown in FIG. 2;

FIG. 4 is plan view of the dive plane shown in FIG. 2.

Like reference numerals refer to like parts throughout the several views of the drawings.

### DETAILED DESCRIPTION OF THE PREFERRED EMBODIMENTS

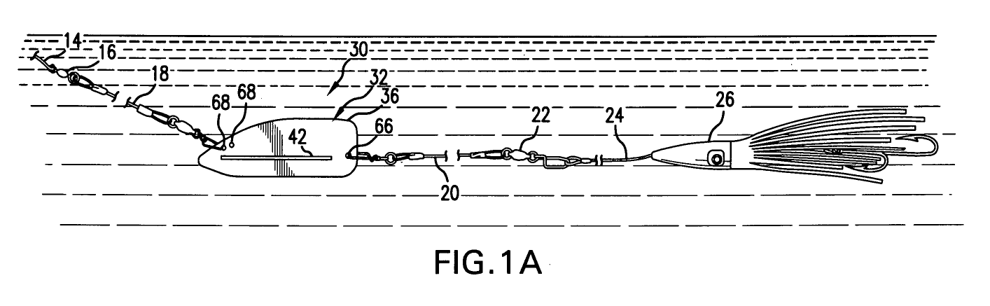

For purposes of description herein, the terms “upper”, “lower”, “left”, “rear”, “right”, “front”, “vertical”, “horizontal”, and derivatives thereof shall relate to the invention as oriented in FIG. 2. However, one will understand that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

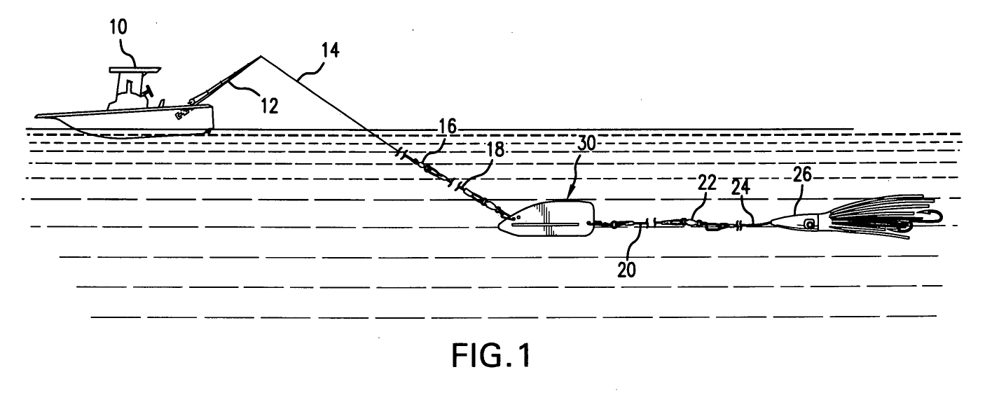

Turning to the drawings, FIGS. 1 and 1A depict a dive plane 30 used in combination with fishing tackle when a boat 10 is trolling for fish. FIG. 2 shows dive plane 30 according to one of the preferred embodiments of the present invention and illustrating its various components and characteristics.

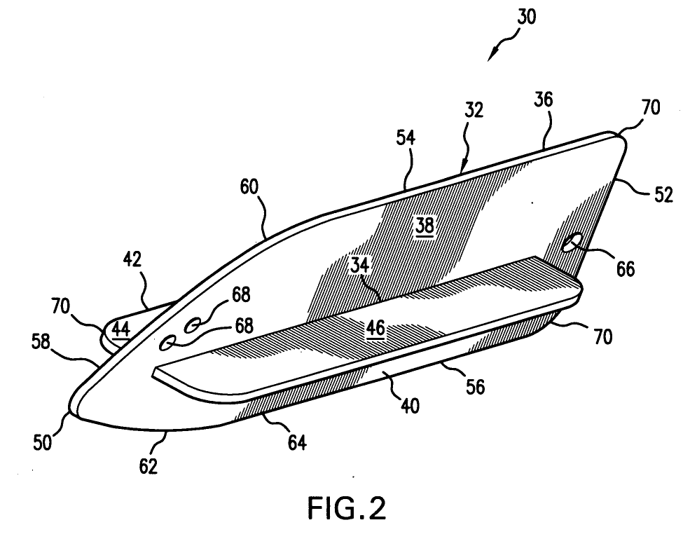

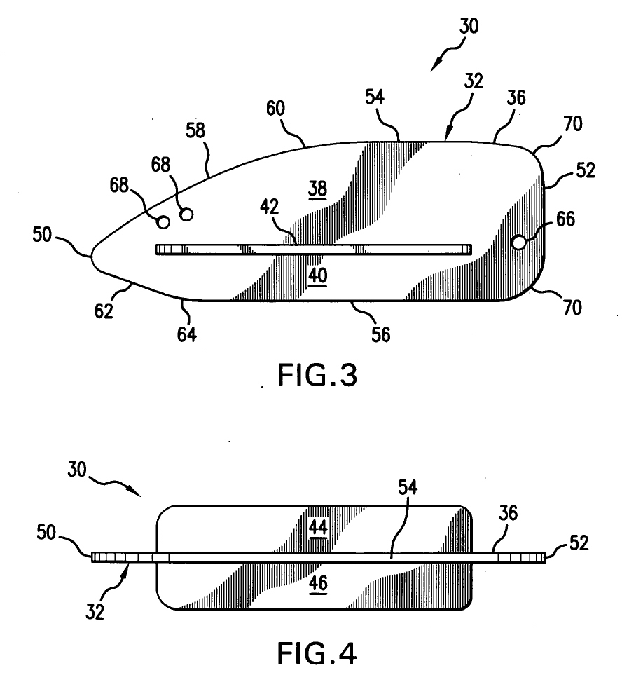

As shown in FIGS. 2-4, dive plane 30 has a body 32 with a generally cruciform shaped cross-section. The cruciform cross section has a vertical plate 36 and a horizontal planing element 42. The intersection 34 of vertical plate 36 and horizontal element 42 divides body 32 into upper vertical segment 38, lower vertical segment 40, right horizontal planing segment 44 and left horizontal planing segment 46. Body 32 is bounded by front edge 50 and back edge 52 defining the length of body 32 and vertical plate 36. Body 32 is further bounded by upper edge 54 and bottom edge 56.

In the most preferred embodiment, front edge 50 of vertical plate 36 divergently tapers toward the back of vertical plate 36. However, the taper is such that it intersects with top edge 54 at a point 60 intermediately along the length of vertical plate 36 thereby defining an upper tapered edge 58. Similarly, the divergent taper also defines a lower tapered edge 62 which intersects lower edge 56 at a point 64 intermediately along the length of vertical plate 36.

Horizontal planing element 42 has a length shorter than body 32 and is positioned intermediate to front edge 50 and back edge 52 and most preferably centered between front edge 50 and back edge 52. Horizontal planing element 42 is also typically positioned vertically such that element 42 is more proximate to bottom edge 56 than to top edge 54. Right and left horizontal planing segments 44, 46 are substantially equal in length and width to provide equal planing forces when dive plane 30 is pulled through the water. Corners such as corners 70 formed by intersecting edges of vertical plate 36 and intersecting edges of horizontal element 42 can be radiused to streamline dive plane 30 to improve water flow therearound.

A plurality of apertures 66 can be defined at back edge of body 32 and most preferably at back edge 52 of vertical plate 36. In the most preferred embodiment, at least one aperture 66 is substantially co-planar with horizontal element 42. A plurality of substantially equally spaced holes 68 are positioned proximate to and along tapered edge 58 of vertical plate 36. In the most preferred embodiment, holes 68 are all positioned above the plane of horizontal element 42; however, holes 68 positioned below the plane of horizontal element 42 are also contemplated.

Dive plane 30 can be constructed of aluminum plates which are fastened together in the above described configuration such as by welding. Alternatively, dive plane 30 can be machined from a block of aluminum to eliminate the need for welding or other attachment of individual segments. Aluminum is a preferred material for construction because of its high strength to weight ratio, its relative resistance to salt water corrosion, and its resistance to damage from a fish biting on dive plane 30 with sharp teeth. Moreover, an anodized protective coating in any of a variety of colors, can be applied to the surfaces of the aluminum dive plane to enhance its appearance and marketability. The use of aluminum is also preferable for environmental reasons. Presently used lead materials in fishing lures, weights and other underwater devices have been determined to be poisonous to sea life. This has led to regulating authorities in some areas of the country to discourage use of lead in fishing tackle. Aluminum, on the other hand, is recyclable and will not harm the underwater environment, particularly living reefs, fish and other sea life.

One configuration of dive plane 30 has typical dimensions wherein the individual segments are one-eighth inch thick and dive plane 30 is seven inches in length, two-and-one-half inches in height, and two inches in width. The weight of a dive plane so configured is approximately two to three ounces and the combined weight with a lure is less than three-fourths of a pound. The combined dive plane 30 and lure can be trolled at speeds of eight to twenty knots with less drag than when prior trolling sinkers and lead lures are used. This reduction in drag permits the use of lighter and less expensive tackle because the strain on the line, rod and reel is reduced.

Referring again to FIGS. 1 and 1A, in use, a fisherman in a boat 10 has a fishing rod 12 which includes a length of fishing line 14. One end of fishing line 14 is affixed to rod 12 and preferably to a reel mounted thereon for easy take-up of fishing line 14. The end of fishing line extending from fishing rod 12 has affixed thereto a first swivel 16 such as a barrel swivel commonly used in fishing tackle. A first steel leader 18 has one end affixed to first swivel 16 and an opposite end affixed to one of front holes 68 of dive plane 30. A second steel leader 20 is affixed to one of the rear apertures 66 in dive plane 30, and an opposite end thereof is affixed to a second swivel 22. Steel leaders are utilized immediately in front of and behind dive plane 30 because sport fish such as wahoo have sharp teeth and can strike at dive plane 30 instead of lure 26 thereby severing non-steel fishing line. A third steel leader 24 has one end attached to second swivel 22 and a lure 26 affixed to an opposite end thereof.

By affixing leaders 18 and 20 to selected ones of front holes 68 and rear apertures 66 respectively, the fisherman can control the depth to which dive plane 30 descends and to which fishing lure 26 is presented to the fish the fisherman desires to catch. The dive plane 30 is pulled through the water from right to left as shown in FIG. 1 and the orientation of dive plane 30 in Figure 2 corresponds thereto. By attaching first leader 18 to an uppermost front hole 68 and second leader to a lowermost rear aperture 66, a rearward tension produced by the drag on fishing lure 26 causes dive plane 30 to rotate counterclockwise thereby angling a front of horizontal planing element 42 downward. This downward angle in turn causes dive plane 30 to submerge until the rearward drag of fishing lure 26 and the forward velocity of boat 10 combined with the upward tension of fishing line 14 operate to level dive plane 30 at which point the depth of dive plane 30 and fishing lure 26 will stabilize.

The combination of rear aperture 66 with an uppermost front hole 68 will maximize the running depth of fishing lure 26, and conversely, using a lowermost front hole 68 with rear aperture 66 will result in a shallower running depth. The shallower running depth position is more preferred for high speed trolling. However, the deeper setting can also be used for high speed trolling, but will result in increased drag forces thereby requiring a commensurately heavier fishing tackle.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

1-20. (canceled)

21. A dive plane for use with fishing tackle for maintaining a fishing lure in a submerged state when trolling for fish, said dive plane comprising:
a one piece integral body including a vertical plate with opposite left and right faces, and a horizontal planing element fixed to said vertical plate to define said integral, one piece body;
said vertical plate having a front end, including a forward most nose, a back end, a top edge, and a bottom edge, said vertical plate divergently tapering from said front end toward said back end, said tapering terminating at said top edge and said bottom edge of said vertical plate intermediately between said front and said back ends, thereby defining an upper tapered edge and a lower tapered edge;
said vertical plate further including first and second forward holes formed through a thickness of said vertical plate defined between said opposite left and right faces, said first and second forward holes located between said nose and said top edge adjacent to said upper tapered edge;
said vertical plate further including a rear hole formed through the thickness of said vertical plate, and said rear hole located adjacent to said back end;
said horizontal planing element including a left horizontal planing segment extending perpendicularly from said left face of said vertical plate, and a right horizontal planing segment extending perpendicularly from said right face of said vertical plate, said left and right horizontal planing segments each including a forward leading edge, a rear trailing edge and an outboard side edge extending between said forward leading edge and said rear trailing edge, and a length of each of said left and right horizontal planing segments being defined by a distance between said forward leading edge and said rear trailing edge of each of said respective left and right horizontal planing segments, and an overall width of said horizontal planing element defined by a linear distance measured perpendicularly between said outboard side edges of said left and right horizontal planing segments; and
said forward leading edge of each of said left and right horizontal planing segments positioned rearward of said nose, and said trailing edge of each of said left and right horizontal planing segments positioned forward of said back end of said vertical plate.

22. The dive plane according to claim 21 wherein said left and right horizontal planing segments are positioned more proximate to said bottom edge of said vertical plate than to said top edge of said vertical plate.

23. The dive plane according to claim 22 wherein corners of said left and right horizontal planing segments and said vertical plate are radiused.

24. The dive plane according to claim 21 wherein said rear hole is co-planar with said left and right horizontal planing segments.

25. The dive plane according to claim 21 wherein said forward leading edge of said left planing segment is perpendicular to said left face of said vertical plate, and said forward leading edge of said right horizontal planing segment is perpendicular to said right face of said vertical plate.

26. The dive plane according to claim 21 wherein said rear trailing edge of said left horizontal planing segment is perpendicular to said left face of said vertical plate, and said rear trailing edge of said right horizontal planing segment is perpendicular to said right face of said vertical plate.

27. The dive plane according to claim 21 wherein said vertical plate has an overall height measured between said top edge and said bottom edge, and said overall height of said vertical plate being greater than said overall width of said horizontal planing element.

28. A dive plane for use with fishing tackle for maintaining a fishing lure in a submerged state when trolling for fish, said dive plane comprising:
a one piece integral body including a vertical plate with opposite left and right faces, and a horizontal planing element fixed to said vertical plate to define said integral, one piece body;
said vertical plate having a front end, including a forward most nose, a back end, a top edge, and a bottom edge, said vertical plate divergently tapering from said front end toward said back end, said tapering terminating at said top edge and said bottom edge of said vertical plate intermediately between said front and said back ends, thereby defining an upper tapered edge and a lower tapered edge, and said vertical plate having an overall height measured between said top edge and said bottom edge;
said vertical plate further including first and second forward holes formed through a thickness of said vertical plate defined between said opposite left and right faces, said first and second forward holes located between said nose and said top edge adjacent to said upper tapered edge;
said vertical plate further including a rear hole formed through the thickness of said vertical plate, and said rear hole located adjacent to said back end;
said horizontal planing element including a left horizontal planing segment extending perpendicularly from said left face of said vertical plate, and a right horizontal planing segment extending perpendicularly from said right face of said vertical plate, said left and right horizontal planing segments each including a forward leading edge, a rear trailing edge and an outboard side edge extending between said forward leading edge and said rear trailing edge, and a length of each of said left and right horizontal planing segments being defined by a distance between said forward leading edge and said rear trailing edge of each of said respective left and right horizontal planing segments, and an overall width of said horizontal planing element defined by a linear distance measured perpendicularly between said outboard side edges of said left and right horizontal planing segments, and said overall height of said vertical plate being greater than said overall width of said horizontal planing element; and
said forward leading edge of each of said left and right horizontal planing segments positioned rearward of said nose, and said trailing edge of each of said left and right horizontal planing segments positioned forward of said back end of said vertical plate.

29. The dive plane according to claim 28 wherein said left and right horizontal planing segments are positioned more proximate to said bottom edge of said vertical plate than to said top edge of said vertical plate.

30. The dive plane according to claim 29 wherein corners of said left and right horizontal planing segments and said vertical plate are radiused.

31. The dive plane according to claim 28 wherein said rear hole is co-planar with said left and right horizontal planing segments.

32. The dive plane according to claim 28 wherein said forward leading edge of said left planing segment is perpendicular to said left face of said vertical plate, and said forward leading edge of said right horizontal planing segment is perpendicular to said right face of said vertical plate.

33. The dive plane according to claim 28 wherein said rear trailing edge of said left horizontal planing segment is perpendicular to said left face of said vertical plate, and said rear trailing edge of said right horizontal planing segment is perpendicular to said right face of said vertical plate.
